(19) United States
(12) Patent Application Publication
(10) Pub. No.: US 2008/0305785 A1
(43) Pub. Date: Dec. 11, 2008

(54) Information processing apparatus

(75) Inventor: Koichi Ito, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 11/983,198

(22) Filed: Nov. 7, 2007

(30) Foreign Application Priority Data
Jun. 8, 2007 (JP) P2007-152850

(51) Int. Cl. H04M 3/00

(52) U.S. Cl. 455/418

(57) ABSTRACT

According to one embodiment of the invention, there is provided an information processing apparatus including: an input acceptance unit configured to accept an input of an incoming call condition for causing another information processing apparatus connected to the information processing apparatus; a transmission unit configured to transmit information about the incoming call condition when a call is originated to another information processing apparatus; a determination unit configured to determine whether or not a line disconnection request for requesting disconnection of a line remaining connected to another information processing apparatus, until establishment of a connection to another information processing apparatus is completed; and a line disconnection unit configured to disconnect the line remaining connected to another information processing apparatus if the determination unit determines that the line disconnection request is acquired.

### CROSS-REFERENCE TO RELATED APPLICATIONS

This application is based on and claims the benefit of priority from the prior Japanese Patent Application No. 2007-152850, filed on Jun. 8, 2007; the entire contents of which are incorporated herein by reference.

### TECHNICAL FIELD

The present invention relates to an information processing apparatus and, more particularly, to an information processing apparatus capable of controlling originating connection in accordance with a status of equipment of an information processing apparatus.

### BACKGROUND

### Description of Related Art

A technique for controlling originating connection in accordance with a status of equipment of a portable terminal, typified by a portable cellular phone and the like, is recently known (see, e.g., JP-A-2001-91120 and JP-A-2003-403389).

The technique proposed in JP-A-2001-91120 enables management of the status of equipment of the portable cellular phone when the power of the portable cellular phone remains deactivated by means of providing a network with a notification of deactivation of power. For instance, when another portable cellular phone has made originating connection, the portable cellular phone of a calling party can be provided with a guidance as to whether a target portable cellular phone cannot be called because the phone is out of cell phone service range or the power remains off.

According to the technique proposed in JP-A-2003-403389, urgent call-origination processing is performed when the power of the portable cellular phone is off, and call origination and registration of a position can be prohibited.

The technique described in Patent Document 1 enables reporting of the status of the target portable cellular phone to another call-originating portable cellular phone by means of a guidance when the other call-originating portable cellular phone (i.e., the reason why a connection from another portable cellular phone cannot be established can be reported). However, whether to establish connection at the time of origination of a call is dependent on the convenience of a network system (a network including a wireless circuit) or whether or not a called portable cellular phone can be connected by a wireless circuit (i.e., whether or not the status of the called portable cellular phone is out of service range, the phone is powered off, the phone is set to a drive mode, or the phone is set to a call rejection mode). At the time of origination of a call, the portable cellular phone of the calling party cannot determine whether to establish connection with a portable cellular phone of a called party.

For instance, in a case where a user does not want to make a call by means of a portable cellular phone when his/her child is in school but desires to make a call when the child is now out of school, even when the user has originated a call from his/her portable cellular phone to a portable cellular phone of his/her child, the user cannot ascertain why connection cannot be made to the child's cellular phone because the portable cellular phone is out of cell service range or powered off or why communication cannot be made immediately because the phone is set to a manner mode or a drive mode. So long as the portable cellular phone owned by the child is connectable, call origination processing is performed unconditionally regardless of the state of the portable cellular phone.

Therefore, under the situation where the portable cellular phone of the called party is to be set in a manner mode or a drive mode (for example, the situation where the called party is in conference or in class) and where the phone of the called party is not set in such a way, when call origination processing has been inadvertently made by a portable cellular phone of the calling party in spite of the fact that the user owning the portable cellular phone of the called party is difficult to make conversation, an unwanted ringing melody or an unwanted vibration sound arises, thereby imposing an inconvenience on the user.

### SUMMARY

According to one embodiment of the invention, there is provided an information processing apparatus including: an input acceptance unit configured to accept an input of an incoming call condition for causing another information processing apparatus connected to the information processing apparatus to perform incoming call processing; a transmission unit configured to transmit information about the incoming call condition accepted as an input by the input acceptance unit when a call is originated to another information processing apparatus; a determination unit configured to determine whether or not a line disconnection request for requesting disconnection of a line remaining connected to another information processing apparatus, until establishment of a connection to another information processing apparatus is completed; and a line disconnection unit configured to disconnect the line remaining connected to another information processing apparatus if the determination unit determines that the line disconnection request is acquired.

### BRIEF DESCRIPTION OF THE DRAWINGS

In the accompanying drawings:

FIG. 1 is an exemplary view showing general configuration of a network system according to an embodiment;

FIGS. 2A, 2B are exemplary external views showing the external configuration of a portable cellular phone applicable to an information processing apparatus according to the embodiment;

FIGS. 3A, 3B are exemplary external views showing another external configuration of the portable cellular phone applicable to the information processing apparatus according to the embodiment;

FIG. 4 is an exemplary block diagram showing the internal configuration of the portable cellular phone applicable to the information processing apparatus according to the embodiment;

FIG. 5 is an exemplary flowchart for describing call origination control processing performed by the portable cellular phone shown in FIG. 4;

FIG. 6 is an exemplary view showing an example display of an incoming call condition input screen displayed on a liquid-crystal display shown in FIG. 4;

FIG. 7 is an exemplary flowchart for describing incoming call control processing performed by the portable cellular phone shown in FIG. 4; and

FIG. 8 is an exemplary flowchart for describing another incoming call control processing performed by the portable cellular phone shown in FIG. 4.

### DESCRIPTION OF THE EMBODIMENTS

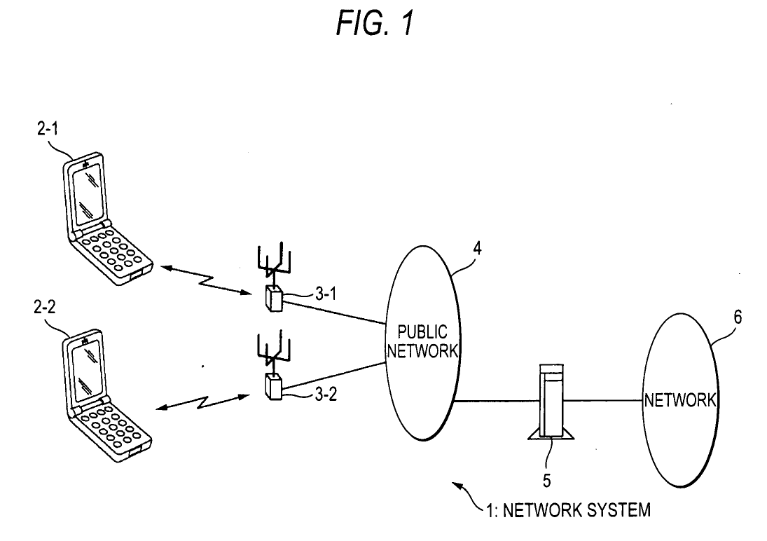

An embodiment of the present invention will be described hereunder by reference to the drawings. FIG. 1 shows the entire configuration of a network system 1. As shown in FIG. 1, the network system 1 is provided with cell sites 3-1 and 3-2 which are stationary radio stations and installed in cells, wherein the cells are determined by dividing into a desired size an area where a communication service is rendered. The cell sites 3-1 and 3-2 are connected, through radio communication, to portable cellular phones 2-1 and 2-2 which are mobile radio stations by means of a code division multiple access mode called; for example, a W-CDMA (Wideband-Code Division Multiple Access).

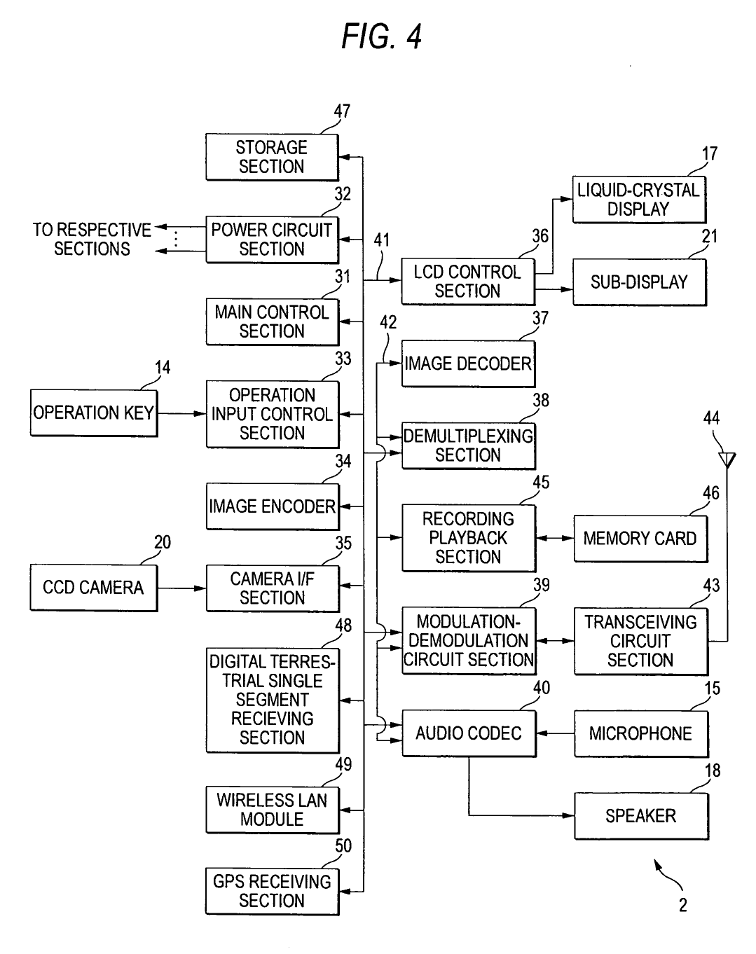

The cell sites 3-1 and 3-2 are connected to a public network 4 by a wire circuit, and the public network 4 is connected to an access server 5 of the Internet service provider. The access server 5 is also connected to various contents servers (not shown) by a network 6 [including, e.g., the Internet, an LAN (Local Area Network), a WAN (Wide Area Network), and various other networks]. In the network system 1, the portable cellular phones 2-1 and 2-2 can receive a digital terrestrial single-segment broadcast wave from an unillustrated broadcast station by a digital terrestrial single-segment broadcast receiving section (e.g., a digital terrestrial single segment receiving section 48 shown in FIG. 4). Moreover, the portable cellular phones 2-1 and 2-2 each can establish short-range large-capacity communication by a built-in wireless LAN module (e.g., a wireless LAN module 49 shown in FIG. 4).

When the portable cellular phones 2-1 and 2-2 do not need to be distinguished from each other, the phones are generically called a portable cellular phone 2 in the following descriptions. When the cell sites 3-1 and 3-2 do not need to be distinguished from each other, the sites are also generically called a cell site 3 in the following descriptions.

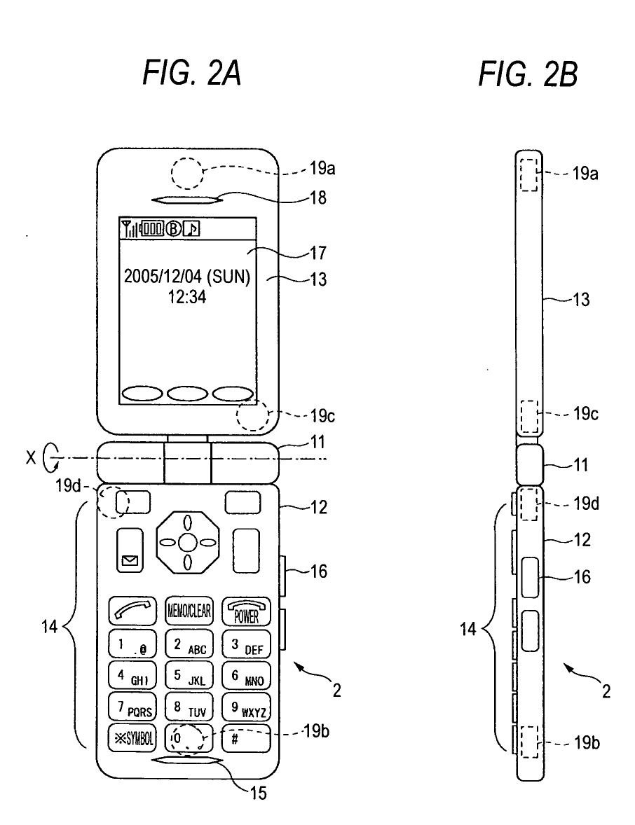

FIG. 2A shows the external configuration of the portable cellular phone 2 opened through about 180° when viewed from the front. FIG. 2B shows the external configuration of the portable cellular phone 2 opened into a two-page spread when viewed from the side.

As shown in FIGS. 2A and 2B, a first housing 12 and a second housing 13 are hinged to each other by a center hinge section 11, and the portable cellular phone 2 is formed so as to be collapsible in the direction of arrow X by the hinge section 11. An antenna for transceiving purpose (an antenna 44 shown in FIG. 4 to be described later) is placed at a predetermined position in the portable cellular phone 2, and a radio wave is exchanged with the cell site 3 by the built-in antenna.

Operation keys 14 including numeric keypads 0 through 9, a call origination key, a redialing key, a call termination/power key, a clear key, and an electronic mail key are provided on a surface of the first housing 12, and various instructions can be inputted by use of the operation keys 14.

A cross key and an enter key are provided as the operation keys 14 at upper positions on the first housing 12. The user can vertically or horizontally move an assigned cursor by vertically or horizontally actuating the cross key. Specifically, there are performed various operations, such as scrolling of a phone list or electronic mails displayed on a liquid-crystal display 17 provided in the second housing 13, turning of a page of a simple home page, transmission of an image, and the like.

Various functions can be determined by means of depressing the enter key. For instance, in the first housing 12, when a desired phone number is selected from a plurality of phone numbers in a list of a telephone directory displayed on the liquid-crystal display 17 according to operation of the cross key performed by the user and when the enter key is pressed inwardly of the first housing 12, the thus-selected phone number is determined, and there is performed processing for originating a call to the thus-determined phone number.

Moreover, the first housing 12 has an electronic mail key which is provided on the left of the cross key and the enter key. When the electronic mail is depressed inwardly of the first housing 12, the function of transmitting and receiving an electronic mail can be invoked. A browse key is provided on the right of the cross key and the enter key. When the browse key is depressed inwardly of the first housing 12, data pertaining to a Web page can be browsed.

A microphone 15 is provided beneath the operation keys 14 on the first housing 12, and user's voice is collected by means of the microphone 15. Further, the first housing 12 is equipped with a side key 16 used for operating the portable cellular phone 2.

An unillustrated battery pack is attached to the back of the first housing 12. When the call termination/power key is turned on, power is supplied from the battery pack to respective circuit sections, whereby the portable cellular phone is started up in an operable manner.

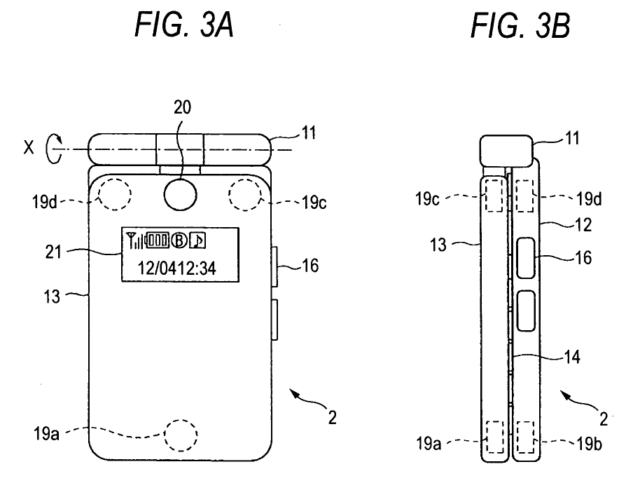

In the meantime, a liquid-crystal display 17 (a main display) is provided in the front of the second housing 13. In addition to displaying a receiving status of a radio wave, remaining power life, names and phone numbers registered in a telephone directory, a transmission log, the liquid-crystal display 17 displays details of electronic mails, a simple home page, images captured by a CCD (Charge-Coupled Device) camera (a CCD camera 20 of FIG. 3 to be described later), contents received from an external contents server (not shown), and contents stored in a memory card (a memory card 46 of FIG. 4 to be described later). Further, a speaker 18 is placed at a predetermined location above the liquid-crystal display 17, whereby the user can perform voice conversation.

FIG. 3 shows another external configuration of the portable cellular phone 2 applicable as the information processing apparatus. The status of the portable cellular phone 2 shown in FIG. 3 corresponds to the status of the portable cellular phone 2 of FIGS. 2A, 2B achieved when the portable cellular phone is rotated along the direction of arrow X. FIG. 3A shows the external configuration of the closed portable cellular phone 2 viewed from the front, and FIG. 3B shows the external configuration of the closed portable cellular phone 2 viewed from the side.

The CCD camera 20 is provided in an upper portion of the second housing 13, thereby enabling acquisition of an image of a desired object of photographing. A sub-display 21 is provided below the CCD camera 20. An antenna pictograph showing the current sensitive level of the antenna, a battery pictograph showing the current battery life of the portable cellular phone 2, a current time, and the like, are displayed on the sub-display 21.

FIG. 4 shows the internal configuration of the portable cellular phone 2 applicable as the information processing apparatus. As shown in FIG. 4, the portable cellular phone 2 is configured by means of connecting a main control section 31 which comprehensively controls individual sections of the first housing 12 and the second housing 13 mutually to a power circuit section 32, an operation input control section 33, an image encoder 34, a camera interface section 35, an LCD (Liquid-Crystal Display) control section 36, a demultiplexing section 38, a modulation-demodulation circuit section 39, an audio codec 40, a storage section 47, the digital terrestrial single segment receiving section 48, a wireless LAN module 49, and a GPS receiving section 50 by a main bus 41; and interconnecting the image encoder 34, the image decoder 37, the demultiplexing section 38, the modulation-demodulation circuit section 39, the audio codec 40, and a recording playback section 45 by a synchronous bus 42.

The main control section 31 is built from a CPU (Central Processing Unit), ROM (Read Only Memory), RAM (Random Access Memory), and the like. The CPU comprehensively controls the portable cellular phone 2 by means of executing various processing operations in accordance with a program stored in the ROM and various application programs loaded into the RAM from the storage section 47; generating various control signals; and supplying the thus-generated control signals to respective sections. The RAM stores, as required, data necessary for the CPU to perform various processing operations.

In accordance with control of the main control section 31, the portable cellular phone 2 converts and compresses an audio signal, which is collected by the microphone 15 in a voice conversation mode, into a digital audio signal by means of the audio codec 40; subjects the digital audio signal to spread spectrum processing by means of the modulation-demodulation circuit section 39; subjects the audio signal to digital-to-analogue conversion processing frequency conversion processing; and transmits the thus-processed signal by the antenna 44.

The portable cellular phone 2 amplifies the signal received by the antenna 44 during the voice conversation mode; subjects the amplified signal to frequency conversion processing and analogue-to-digital conversion processing; subjects the thus-converted signal to inverse spread spectrum by means of the modulation-demodulation circuit section 39; expands the signal by means of the audio codec 40; converts the signal into an analogue audio signal; and outputs the thus-converted analogue audio signal by the speaker 18.

When transmitting an image signal in a data communications mode, the portable cellular phone 2 supplies an image signal captured by the CCD camera 20 to the image encoder 34 by the camera interface section 35.

The image encoder 34 converts the image signal supplied from the CCD camera 20 into an encoded image signal by means of subjecting the image signal to compression encoding according to a predetermined encoding scheme; for example, MPEG (Moving Picture Experts Group) 4 or the like; and transmits the thus-converted encoded image signal to the demultiplexing section 38. At this time, the portable cellular phone 2 simultaneously transmits, as a digital audio signal, the sound—which is collected by the microphone 15 in the middle of an image being captured by the CCD camera 20—to the demultiplexing section 38 by the audio codec 40.

The demultiplexing section 38 multiplexes an encoded image signal supplied from the image encoder 34 and the audio signal supplied from the audio codec 40 by means of a predetermined scheme; subjects a resultantly-obtained multiplexed signal to spread spectrum processing in the modulation-demodulation circuit section 39; subjects the thus-processed signal to digital-to-analogue conversion processing and frequency conversion processing by means of the transceiving circuit section 43; and transmits the thus-processed signal by the antenna 44. In contrast, the portable cellular phone 2 can receive data pertaining to a Web page during the data communications mode.

When the portable cellular phone 2 receives data pertaining to; for example, a motion picture file linked to the Web page, during the data communications mode, the modulation-demodulation circuit section 39 subjects the signal received from the cell site 3 by the antenna 44 to inverse spread spectrum processing, and a resultantly-obtained multiplexed signal is transmitted to the demultiplexing section 38.

The demultiplexing section 38 separates the multiplexed signal into an encoded image signal and an audio signal, supplying the encoded image signal to the image decoder 37 by the synchronous bus 42 and supplying the audio signal to the audio codec 40. The image decoder 37 generates decodes the encoded image signal by means of a decoding scheme appropriate for the predetermined encoding scheme, such as MPEG 4, to thus generate a playback image signal; and supplies the thus-generated playback image signal to the liquid-crystal display 17 by the LCD control section 36. Thereby, motion picture data included in; for example, a motion picture file linked to a Web page, are displayed.

At this time, the audio codec 40 simultaneously converts the audio signal into an analogue audio signal and subsequently supplies the analogue audio signal to the speaker 18, whereby an audio signal included in; for example, the motion picture file linked to the Web page, is played back.

The storage section 47 is built from; for example, a flash memory element corresponding to nonvolatile memory which can be electrically rewritten or erased or an HDD (Hard Disc Drive), and stores various application programs and a group of various sets of data executed by the CPU of the main control section 31.

The digital terrestrial single segment receiving section 48 receives a digital terrestrial single-segment broadcast wave from an unillustrated broadcast station and supplies the thus-received digital terrestrial single-segment broadcast wave to the demultiplexing section 38 or the storage section 47.

The wireless LAN module 49 performs wireless LAN communication complying with a predetermined standard, such as IEEE802.11a/b/g, by a built-in antenna (not shown).

The GPS receiving section 50 receives a GPS wave (GPS information) from an unillustrated GPS satellite. The GPS information includes; for example, information about a time of transmission from each GPS satellite. Subsequently, the main control section 31 computes positional information (information about a longitude and a latitude) showing the current position of the portable cellular phone 2 by use of the acquired GPS information, thereby determining positional information (positional information determined through GPS positioning) showing the current position of the portable cellular phone 2. Although acquiring a longitude and a latitude as positional information determined from the GPS information is, common, information about an address corresponding to the latitude and the longitude may also be acquired. When information about an address corresponding to a latitude and a longitude is acquired, address information may also be acquired by making an access to an external server (not shown). Accordingly, the “positional information determined through GPS positioning” is assumed to include positional information (e.g., information about a latitude and a longitude) computed from the GPS information, address information corresponding to the positional information, and the like.

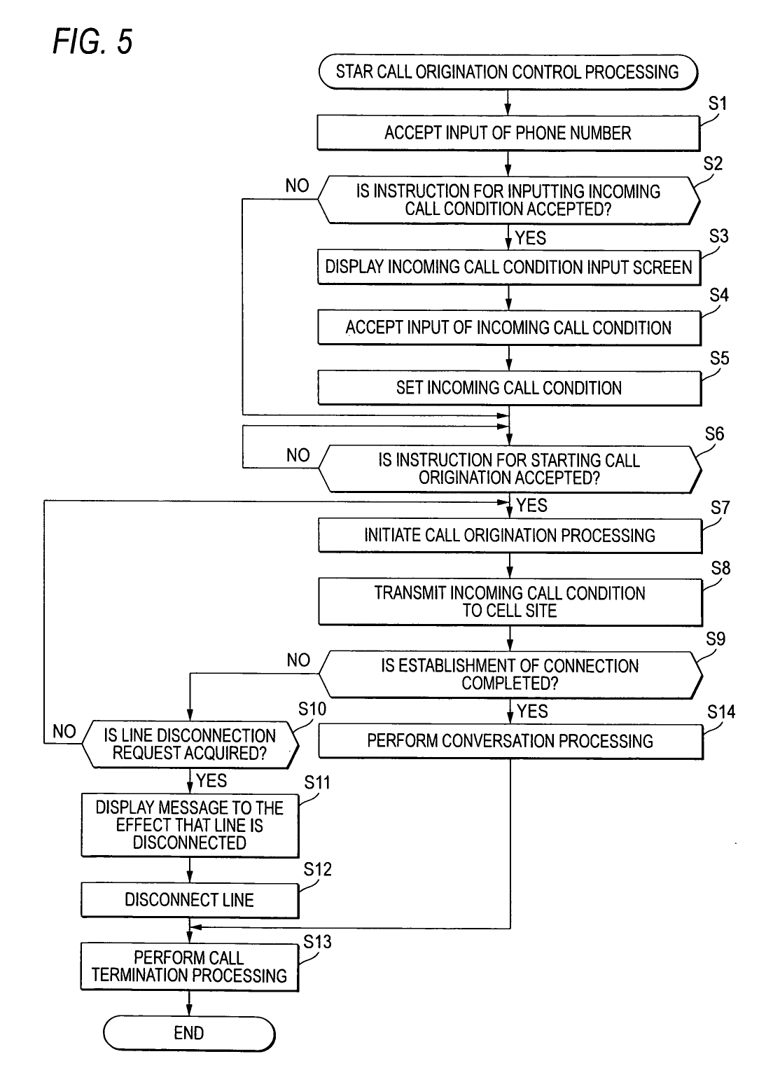

Call-original control processing performed by the portable cellular phone 2 shown in FIG. 4 will now be described by reference to a flowchart shown in FIG. 5. For example, a case where the portable cellular phone 2-1 shown in FIG. 1 originates a call to the portable cellular phone 2-2 will be described in connection with call-original control processing shown in FIG. 5. The portable cellular phone 2-1 of FIG. 1 serving as a calling party is referred to as a “calling portable cellular phone 2,” and the portable cellular phone cellular phone 2-2 of FIG. 1 serving as a called party is referred to as a “called portable cellular phone 2.”

In step S1, the main control section 31 accepts, on a screen, an input of any phone number (i.e., a phone number for which the user desires to perform call origination processing) as a result of the user operating the operation keys 14 by the operation input control section 33. For instance, an input of a phone number, such as “090-xxxx-xxxx” is accepted. As a matter of course, it may also be the case where, as a result of any phone number being selected from several phone numbers previously displayed on a screen, an input of the thus-selected phone number will be accepted. Alternatively, it may also be the case where the user will be prompted to select a phone number registered in a telephone directory and where a phone number will be accepted in accordance with the input.

In step S2, the main control section 31 determines whether or not an instruction to input incoming call conditions for causing the called portable cellular phone 2 (e.g., the portable cellular phone 2-2 shown in FIG. 1) connected to the calling portable cellular phone 2 (e.g., the portable cellular phone 2-1 shown in FIG. 1) to perform incoming call processing has been accepted by the operation input control section 33.

When in step S2 the instruction to input incoming call conditions for causing the called portable cellular phone 2 connected to the calling portable cellular phone 2 to perform incoming call processing is determined to have been accepted, the main control section 31 controls the LCD control section 36 in step S3, thereby causing the liquid-crystal display 17 to display an incoming call condition input screen for use in inputting incoming conditions. In accordance with control of the LCD control section 36, the liquid-crystal display 17 displays an incoming call condition input screen for inputting incoming call conditions.

Conceivable incoming call conditions for causing the called portable cellular phone 2 to perform (initiate) incoming call processing include; for example, (a) a case where the called portable cellular phone is in a predetermined area; (b) a case where the called portable cellular phone 2 is not in the predetermined area; (c) a case where the called portable cellular phone 2 is now on the move; (d) a case where the called portable cellular phone 2 allows (admits) a collect call; (4) a case where the called portable cellular phone 2 allows (admits) a long-duration conversation; (f) a case where the called portable cellular phone 2 is not set to wait for an urgent call; (g) a case where a current time does not fall within a call-rejection period previously set in the called portable cellular phone 2; (h) a case where a battery life is sufficient; and (i) a case where the phone is not set to a manner mode. Hereinafter, “the manner mode” means a mode without sound when incoming call is coming or when a message is received.

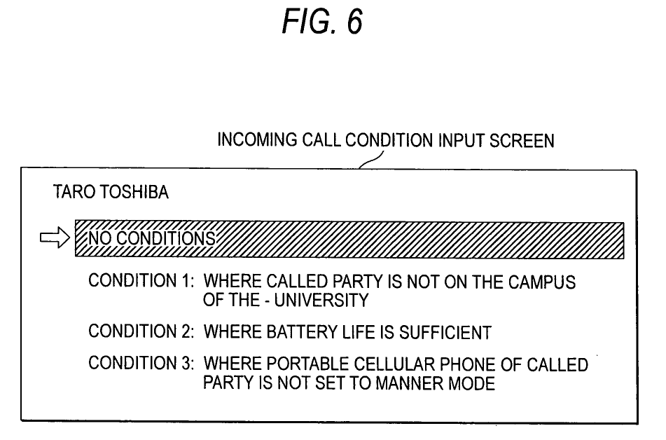

When an instruction to input incoming call conditions for causing the called portable cellular phone 2 to perform incoming call processing is accepted, an incoming call condition input screen shown in, e.g., FIG. 6, is displayed on the liquid-crystal display 17. In the case of the incoming call condition input screen shown in FIG. 6, “No Conditions,” “Condition 1: where a called party is not on the campus of the—University,” “Condition 2: where battery life is sufficient,” and “Condition 3: where the phone is not set to a manner mode” are displayed in order from top as conditions for causing the called portable cellular phone 2 to perform call receiving operation. The “No Conditions” displayed on the incoming call condition input screen signifies conditions for causing the called portable cellular phone 2 to perform ordinary call receiving operation without specifying any incoming call conditions for causing the called portable cellular phone 2 to perform incoming call processing. In addition, in this case, an owner of the called portable cellular phone 2 (e.g., the portable cellular phone 2-2 shown in FIG. 1) is “Taro Toshiba.”

A focusing section is scrolled as a result of the user operating the operation key 14 (e.g., a cross key or the like), whereby a desired incoming call condition (e.g., “Condition 1: where a called party is not on the campus of the—University” or the like) is selected from several incoming call conditions displayed on the incoming call condition input screen, and the thus-selected incoming call condition is input. “No Conditions” may also be set as; for example, an initial setting. A user of a called side who wants the user to use such an incoming call condition input function is conceived to be usually a regular party. Therefore, a desired incoming call condition may be previously selected from a menu by use of; for example, a telephone directory function, and registered rather than such an incoming call condition being input every time the calling portable cellular phone 2 performs call origination processing. When the telephone directory is opened, any one may be elected from a plurality of registered incoming call conditions.

In order to perform call origination control processing after “where the called portable cellular phone 2 allows (admits) long-duration conversation,” such as that mentioned above, has been set as an incoming call condition in the calling portable cellular phone 2 (e.g., the portable cellular phone 2-1 shown in FIG. 1), the called portable cellular phone 2 is required to have been previously set to allow (admit) long-duration conversation. Likewise, in order to perform call origination control processing after “where the called portable cellular phone 2 is not set to wait for an urgent call” has been set as an incoming call condition in the calling portable cellular phone 2 (e.g., the portable cellular phone 2-1 shown in FIG. 1), the called portable cellular phone 2 is required to have been previously set to wait for an urgent call. The same also applies to the condition “where a current time does not fall within a call-rejection period previously set in the called portable cellular phone 2.”

A plurality of such incoming call conditions may also be set simultaneously. Moreover, where a called portable cellular phone is not receiving a digital terrestrial single-segment radio broadcast wave, or the like, may also be adopted as an incoming call condition. Further, a change may also be made to the incoming call conditions, as required, in accordance with preferences of the user. As a matter of course, it may also be the case where incoming call conditions will not be input in the case of portable cellular phones of the same model manufactured by the same manufacturer and where numbers indicating incoming call conditions may only be exchanged between these portable cellular phones. Furthermore, it may also be the case where incoming call conditions selected by a called party will previously be sent to a calling party and where the calling party will select any from the thus-received incoming call conditions.

In step S4, as a result of the user depressing the enter key after having operated; for example, the cross key, among the operation keys 14 by the operation input control section 33, the main control section 31 accepts an input of incoming call conditions for causing the called portable cellular phone 2 to perform incoming call processing. For example, in the case of FIG. 6, an input of “Condition 1: where a called party is not on the campus of the—University” is accepted as an incoming call condition for causing the called portable cellular phone 2 to perform incoming call processing.

In step S5, in accordance with the incoming call condition accepted as an input, the main control section 31 sets the incoming call condition for causing the called portable cellular phone 2 to perform incoming call processing. In step S6, the as a result of the user operating; for example, a call origination key, among the operation keys 14 by the operation input control section 33, the main control section 31 determines whether or not an instruction to start originating a call to the called portable cellular phone 2 is accepted, and waits until the instruction to start originating a call to the called portable cellular phone 2 is determined to be accepted.

When the instruction to start originating a call to the called portable cellular phone 2 is determined to be accepted in step S6, the main control section 31 controls, in step S7, the modulation-demodulation circuit section 39, the transceiving circuit section 43, and the antenna 44, thereby initiating processing for originating a call to the called portable cellular phone 2 indicated by the phone number accepted as an input. In step S8, the main control section 31 controls the modulation-demodulation circuit section 39, the transceiving circuit section 43, and the antenna 44, thereby transmitting information about the set incoming call condition (an incoming call condition serving as a condition for causing the called portable cellular phone 2 to perform incoming call processing) to the called portable cellular phone 2 by the cell site 33.

Information about the incoming call condition includes specifics of the set incoming call condition (“Condition 1: where a called party is not on the campus of the—University,” “Condition 2: where battery life is sufficient,” “Condition 3: where a called portable cellular phone is not set to a manner mode,” or the like).

In step S9, the main control section 31 controls the modulation-demodulation circuit section 39, the transceiving circuit section 43, and the antenna 44, thereby determining, from connection of a line to the calling portable cellular phone 2 initiated call origination processing, whether or not establishment of connection to the called portable cellular phone 2 is completed.

When in step S9 establishment of connection to the calling portable cellular phone 2 is determined not to be completed, the main control section 31 determines, in step S10, whether or not a line disconnection request for requesting disconnection of a line is acquired from the called portable cellular phone 2 by the modulation-demodulation circuit section 39, the transceiving circuit section 43, and the antenna 44. The line disconnection request is transmitted from the called portable cellular phone 2 when completion of establishment of connection to the line is not allowed because the incoming call condition transmitted from the calling portable cellular phone 2 (e.g., the portable cellular phone 2-1 shown in FIG. 1) is not fulfilled by the called portable cellular phone 2 (e.g., the portable cellular phone 2-2 shown in FIG. 1). Hereinafter, a state of “a completion of establishment of connection to the line” is a state capable of communicating with a recipient of the phone call received from the calling portable cellular phone 2 via a voice.

When in step S10 the line disconnection request for requesting disconnection of a line is determined not to be acquired from the called portable cellular phone 2 (i.e., when completion of connection of the line is not allowed because the incoming call condition transmitted from the calling portable cellular phone 2 is not fulfilled by the called portable cellular phone 2 or when establishment of connection to the called portable cellular phone 2 has not yet been completed though the incoming call condition transmitted from the calling portable cellular phone 2 is fulfilled by the called portable cellular phone 2), processing returns to step S7, and processing pertaining to steps subsequent to step S7 is repeatedly performed.

In the meantime, when in step S10 the line disconnection request for requesting disconnection of a line is determined to be acquired from the called portable cellular phone 2, the main control section 31 displays on the liquid-crystal display 17 a message to the effect that the line connected to the called portable cellular phone 2 is disconnected, by the LCD control section 36. In accordance with control of the LCD control section 36, the liquid-crystal display 17 displays a message to the effect that the line connected to the called portable cellular phone 2 is disconnected. For instance, a message to the effect that a line is disconnected because incoming call conditions are not fulfilled” is displayed. As a matter of course, the unfulfilled incoming call condition per se may also be displayed concurrently.

In step S12, the main control section 31 disconnects the line connected to the called portable cellular phone 2 for which call origination processing has been initiated, by the modulation-demodulation circuit section 39, the transceiving circuit section 43, and the antenna 44. As a result, when completion of connection of the line is not allowed by the called portable cellular phone 2 because the incoming call condition transmitted from the calling portable cellular phone 2 is not fulfilled by the called portable cellular phone 2, the line connected to the called portable cellular phone 2 can be disconnected.

In step S13, the main control section 31 performs call termination processing, by the modulation-demodulation circuit section 39, the transceiving circuit section 43, and the antenna 44.

When establishment of connection to the called portable cellular phone 2 is determined to be completed in step S9, the main control section 31 performs conversation processing for making phone conversation with the called portable cellular phone 2 by the modulation-demodulation circuit section 39, the transceiving circuit section 43, and the antenna 44. Thereby, the user can make a conversation with another user who owns the other portable cellular phone 2. Subsequently, when either the user on the calling side or the user on the called side actuates; for example, the call termination/power key among the operation keys 14, processing proceeds to step S13, where call termination processing is performed.

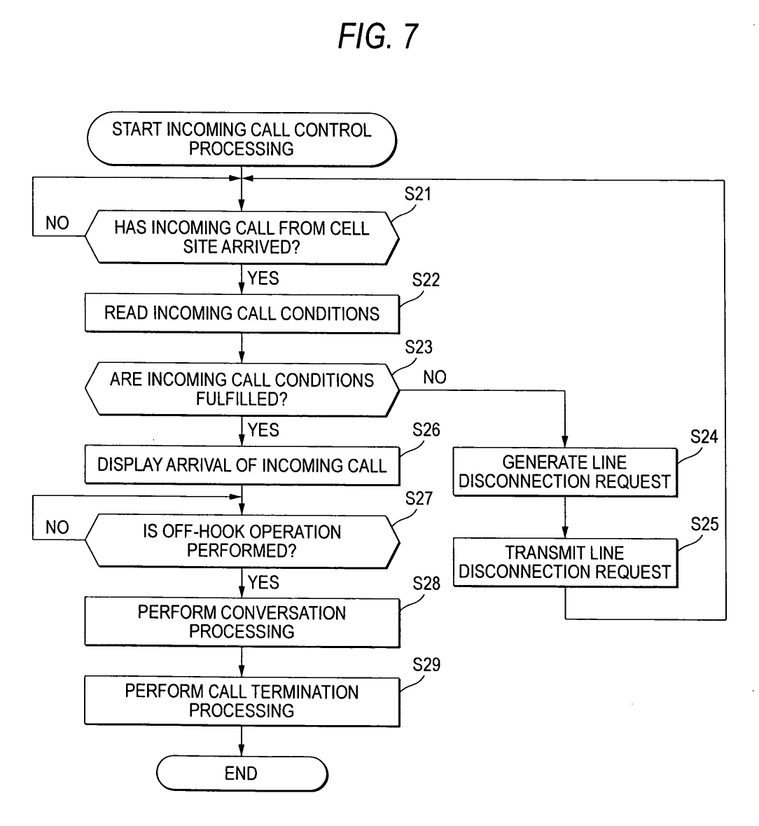

By reference to a flowchart shown in FIG. 7, there will now be described incoming call control processing of the called portable cellular phone 2 (the portable cellular phone 2-2 shown in FIG. 1) of FIG. 4 responding to call origination control processing of the calling portable cellular phone 2 (e.g., the portable cellular phone 2-1 shown in FIG. 1) described by reference to a flowchart shown in FIG. 5.

In step S21, the main control section 31 determines whether or not an incoming call from the calling portable cellular phone 2 (e.g., the portable cellular phone 2-1 of FIG. 1) has arrived by the cell site 3, by the modulation-demodulation circuit section 39, the transceiving circuit section 43, and the antenna 44; and waits until an incoming call from the calling portable cellular phone 2 (e.g., the portable cellular phone 2-1 shown in FIG. 1) is determined to have arrived by the cell site 3.

When in step S21 the incoming call from the calling portable cellular phone 2 (e.g., the portable cellular phone 2-1 shown in FIG. 1) is determined to have arrived by the cell site 3, the main control section 31 reads, in step S22, a required incoming call condition from information about the incoming call condition transmitted from the calling portable cellular phone 2 (e.g., the portable cellular phone). Information about the incoming call conditions includes information about specifics of the set incoming condition (“Condition 1: where a called party is not on the campus of the—University,” “Condition 2: where battery life is sufficient,” “Condition 3: where a called portable cellular phone is not set to a manner mode,” or the like).

In step S23, the main control section 31 determines whether or not the read incoming condition is fulfilled by the called portable cellular phone 2 (e.g., the portable cellular phone 2-2 shown in FIG. 1). Specifically, in the case where the read incoming call condition is “Condition 1: where a called party is not on the campus of the—University,” the read incoming condition is determined not to be fulfilled when the user owning the called portable cellular phone 2 (the portable cellular phone 2-2 shown in FIG. 1) is on the campus of the—University. When a determination is made as to whether or not the user owning the called portable cellular phone 2 (the portable cellular phone 2-2 shown in FIG. 1) is on the campus of the—University, the GPS function is activated, and positional information (positional information determined through GPS positioning) showing the current position of the called portable cellular phone 2 is determined in accordance with a GPS wave (GPS information) received by the GPS receiving section 50 from an unillustrated GPS satellite. A determination is made as to whether or not the user is on the campus of the—University in accordance with the positional information.

In the case where the read incoming condition is “Condition 3: where a called portable cellular phone is not set to a manner mode or the like,” the read incoming call condition is determined not to be fulfilled when the called portable cellular phone 2 (the portable cellular phone 2-2 shown in FIG. 1) is previously set to the manner mode.

When the incoming call condition read in step S23 is determined not to be fulfilled by the called portable cellular phone 2, the main control section 31 generates, in step S24, a line disconnection request for disconnecting a line connected to the calling portable cellular phone 2 (when viewed from the calling portable cellular phone 2, the line disconnection request is for disconnecting a line connected to the called portable cellular phone 2).

In step S25, the main control section 31 controls the modulation-demodulation circuit section 39, the transceiving circuit section 43, and the antenna 44, thereby transmitting the thus-generated line disconnection request to the calling portable cellular phone 2 by the cell site 3. Subsequently, processing proceeds to step S21, and processing pertaining to steps subsequent to step S21 is repeatedly performed.

When the incoming call condition read in step S23 is determined to be fulfilled by the called portable cellular phone 2, in step S26 the main control section 31 causes the liquid-crystal display 17 to display an incoming call indication showing an arrival of an incoming call from the calling portable cellular phone 2 by the LCD control section 36 after waiting for off-hook operation performed by the user. In accordance with control of the LCD control section 36, the liquid-crystal display 17 displays an incoming call indication showing arrival of an incoming call from the calling portable cellular phone 2. For instance, the phone number of the calling portable cellular phone 2 and the name of the user who is the owner of the phone are displayed on the liquid-crystal display 17. At this time, an incoming call sound (a ring tone) is simultaneously output by use of the speaker 18.

In step S27, the main control section 31 determines whether or not on-hook operation is performed as a result of the user operating; for example, a call origination key, among the operation keys 14, by the operation input control section 33, and waits until the off-hook operation is determined to have been performed. When in step S27 the off-hook operation is determined to have been performed, the main control section 31 controls the entire portable cellular phone 2, thereby performing conversation processing. Subsequently, when the user operates the call termination/power key among the operation keys 14, the main control section 31 controls the entire portable cellular phone 2 in step S29, thereby performing call termination processing. As a matter of course, the line connected to the calling portable cellular phone 2 may also be disconnected pursuant to the line disconnection request transmitted as a result of the user of the calling portable cellular phone 2 performing call termination processing.

In the embodiment, there is accepted an input of an incoming call condition for causing the called portable cellular phone 2 (e.g., the portable cellular phone 2-2 shown in FIG. 1) connected to the calling portable cellular phone 2 (e.g., the portable cellular phone 2-1 shown in FIG. 1). At the time of origination of a call to the called portable cellular phone 2, information about the incoming call condition accepted as an input is transmitted to the called portable cellular phone 2. A determination can be made as to whether or not a line disconnection request for requesting disconnection of a line between the calling portable cellular phone 2 and the called portable cellular phone 2 is acquired from the called portable cellular phone 2 until completion of establishment of a connection to the called portable cellular phone 2 (in other words; a determination can be made as to whether or not the incoming call condition transmitted by the called portable cellular phone 2 is fulfilled).

When the line disconnection request is determined to be acquired from the called portable cellular phone 2, a line remaining connected to the called portable cellular phone 2 can be disconnected.

As a result, for example, in a case where the user does not want to make a call by means of the portable cellular phone 2 when his/her child is in school but desires to make a call when the child is now out of school, a line to the called portable cellular phone 2 for which establishment of a connection is initiated can be disconnected when the user has performed processing by means of his/her portable cellular phone 2 (the calling portable cellular phone 2) to originate a call to the portable cellular phone 2 of his/her child (the called portable cellular phone 2) and when the incoming call condition transmitted by the called portable cellular phone 2 is not fulfilled. Accordingly, under the situation where the incoming call condition is not fulfilled by the called portable cellular phone 2, completion of connection of a line can be prevented even when the called portable cellular phone 2 is in a connectable state, thereby preventing unconditional performance of call origination processing.

At this time, a message to the effect that a line is disconnected is displayed on the calling portable cellular phone 2, and the calling portable cellular phone 2 can perform call termination processing. As a result, the user can ascertain whether a connection cannot be established because the portable cellular phone 2 owned by his/her child is out of service range or powered-off or whether a conversation cannot be made because the child's portable cellular phone is set to a manner mode or a drive mode. As mentioned above, the convenience of call origination processing can be enhanced.

Call-origination-and-incoming-call control processing performed between the two portable cellular phones 2 has been explicitly described in the embodiment, the present invention is not limited to such a case and may also be applied to call-origination-and-incoming-call control processing performed between; for example, the portable cellular phone 2 and a land-line phone or a personal computer (neither are illustrated).

Incidentally, in incoming call control processing shown in FIG. 7, when the incoming call condition transmitted from the calling portable cellular phone 2 is not fulfilled, the called portable cellular phone 2 immediately generates a line disconnection request, thereby transmitting the thus-generated line disconnection request to the calling portable cellular phone 2. However, the embodiment is not limited to such a case. For instance, when the incoming condition transmitted from the calling portable cellular phone 2 is not fulfilled, a line is once disconnected. Subsequently, a reason for not communicating, via a voice, with a user of the called portable cellular phone 2 who receives the phone call from the calling portable cellular phone is transmitted, in the form of a voice guidance, to the calling portable cellular phone 2, or data information showing the reason is transmitted. Alternatively, when an electronic mail can be received, a text guidance formed from text data may also be transmitted to the calling portable cellular phone 2. Incoming call control processing using the present method will be described hereunder.

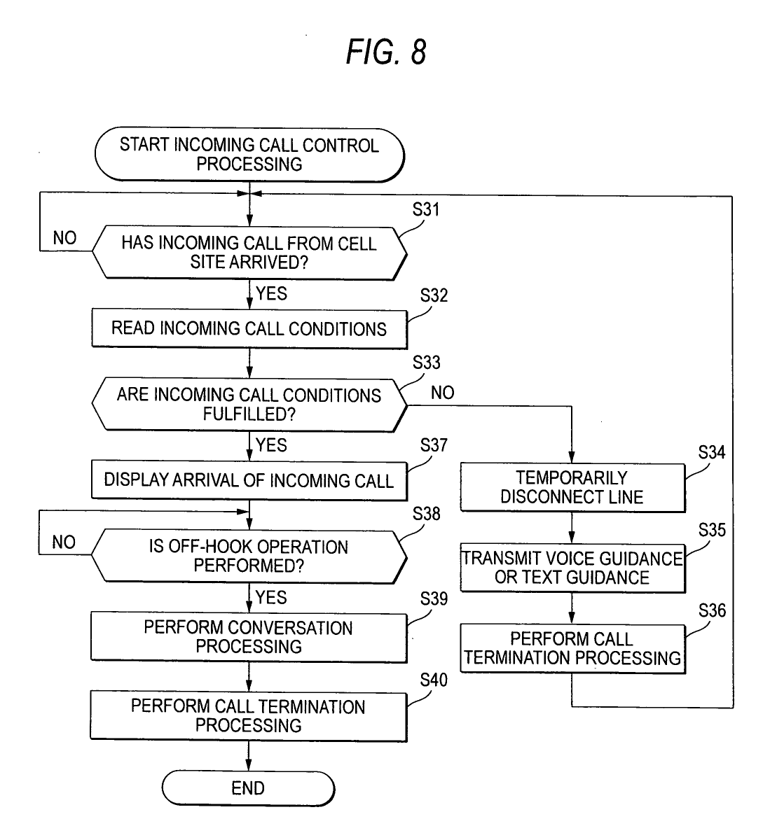

By reference to a flowchart shown in FIG. 8, there will now be described incoming call control processing of the called portable cellular phone 2 (the portable cellular phone 2-2 shown in FIG. 1) of FIG. 4 responding to call origination control processing of the calling portable cellular phone 2 (e.g., the portable cellular phone 2-1 shown in FIG. 1) described by reference to a flowchart shown in FIG. 5. Processing pertaining to steps S31 through S33 and processing pertaining to steps S37 through S40 in FIG. 8 are analogous to processing pertaining to steps S21 through S23 and processing pertaining to steps S26 through S29 in FIG. 7, and repeated their explanations are omitted here for clarity.

When the incoming call condition read in step S33 is determined not to be fulfilled by the called portable cellular phone 2, in step S34 the main control section 31 controls the modulation-demodulation circuit section 39, the transceiving circuit section 43, and the antenna 44, thereby temporarily connecting a line to the calling portable cellular phone 2. In step S35, the main control section 31 reads, from the storage section 47, an audio signal corresponding to a voice guidance showing that the incoming condition (e.g., an incoming condition of “Condition 1: a called party is not on the campus of the—University”) is not fulfilled, and transmits an audio signal corresponding to the thus-read audio guidance to the calling portable cellular phone 2 by the modulation-demodulation circuit section 39, the transceiving circuit section 43, and the antennae 44.

Alternatively, in step S35 the main control section 35 reads from the storage section 47 text data or a data code corresponding to a text guidance showing that the incoming call condition (e.g., an incoming call condition of “Condition 1: a called party is not on the campus of the—University”) is not fulfilled; creates a mail in accordance with the text data corresponding to the thus-read text guidance; and transmits the thus-created mail or the data code to the calling portable cellular phone 2 by the modulation-demodulation circuit section 39, the transceiving circuit section 43, and the antenna 44.

Subsequently, in step S36, the main control section 31 controls the entirety of the portable cellular phone 2, thereby performing call termination processing. Processing then returns to step S31, and processing pertaining to steps subsequent to step S31 is repeatedly performed.

The calling portable cellular phone 2 is temporarily connected with the called portable cellular phone 2 by means of processing pertaining to steps subsequent to step S14 shown in FIG. 5. The audio signal corresponding to the voice guidance or a mail including text data corresponding to the data code or the text guidance sent from the called portable cellular phone 2 is received. The thus-received audio signal corresponding to the voice guidance or the received mail including information corresponding to the data code or the text data corresponding to the text guidance is output by the speaker 18 or the liquid-crystal display 17.

As a result, for example, in a case where the user does not want to make a call by means of the portable cellular phone 2 when his/her child is in school but desires to make a call when the child is now out of school, a connection to the called portable cellular phone 2 for which establishment of a connection is initiated is temporarily established when the user has performed processing by means of his/her portable cellular phone 2 (the calling portable cellular phone 2) to originate a call to the portable cellular phone 2 of his/her child (the called portable cellular phone 2) and when the incoming call condition transmitted by the called portable cellular phone 2 is not fulfilled. Subsequently, the user can directly, readily ascertain the reason why the connection cannot be established (e.g., whether the connection cannot be established because the called portable cellular phone 2 owned by his/her child is out of service range or powered-off, or whether a conversation cannot be made immediately because the child's phone is set to a manner mode or a drive mode). Accordingly, the convenience of call-origination-and-incoming-call processing can be enhanced further.

In this case, communication fees are charged to the user who is the owner of the calling portable cellular phone 2. However, in connection with alterations or additions to the function of the signal scheme of the cell site 3 or the network system 1, such a function can be implemented by means of making the minimum changes or additions. As a matter of course, in relation to communication fees, occurrence of an extra charge can be virtually prevented by utilization of a service which allows you to make a phone call as much as you want.

When the unfulfilled incoming call condition is (g) where a current time does not fall within an incoming-call rejection period previously set in the called portable cellular phone 2, information about a period of time during which an incoming call can be accepted may also be included in the audio signal corresponding to the voice guidance or the test data corresponding to data or the text guidance transmitted from the called portable cellular phone 2 to the calling portable cellular phone 2. Thereby, the convenience of call-origination-and-incoming-call processing can be enhanced further.

Moreover, the service implemented by such call-origination-and-incoming-call control processing can be basically realized by only the portable cellular phone 2. Accordingly, the service does not depend on a system including the cell site 3, and no problem arises even when a portable cellular phone service provider of the calling party differs from a portable cellular phone service provider of the called party. So long as the cell site 3 shares portions of the function and so long as the called portable cellular phone 2 is arranged to previously report all or some of the incoming call conditions to the network side, such as the public network 4, by the cell site 3, the service can be provided by means of only processing performed by the calling portable cellular phone 2.

In the embodiment, such processing may also be performed by use of the wireless LAN module 49 provided in the portable cellular phone 2 and by a wireless LAN circuit. At that time, more detailed information (e.g., positional information or the like) may also be transmitted and received.

In addition to being applied to the portable cellular phone 2, the embodiment can also be applied to a PDA (Personal Digital Assistant), a personal computer, a portable game machine, a portable music payer, a portable motion picture player, and other information processing apparatus.

A round of processing operations described in connection with the embodiment can also be executed by means of hardware as well as by means of software.

Moreover, in the embodiment, steps of the flowchart show example processing performed in time sequence and in the order described herein. However, processing is not necessarily be performed in time sequence, and processing performed in parallel or individually is also included.

According to the embodiment, the convenience of call origination processing can be enhanced.

What is claimed is:

1. An information processing apparatus comprising:
an input acceptance unit configured to accept an input of an incoming call condition for causing another information processing apparatus connected to the information processing apparatus to perform incoming call processing;
a transmission unit configured to transmit information about the incoming call condition accepted as an input by the input acceptance unit when a call is originated to another information processing apparatus;
a determination unit configured to determine whether or not a line disconnection request for requesting disconnection of a line remaining connected to another information processing apparatus, until establishment of a connection to another information processing apparatus is completed; and
a line disconnection unit configured to disconnect the line remaining connected to another information processing apparatus if the determination unit determines that the line disconnection request is acquired.

2. The information processing apparatus according to claim 1, comprising:
a display unit configured to display a message indicating that a line remaining connected to another information processing apparatus is disconnected, if the line disconnection unit disconnects the line remaining connected to another information processing apparatus.

3. An information processing apparatus comprising:
an input acceptance unit configured to accept an input of an incoming call condition for causing another information processing apparatus connected to the information processing apparatus to perform incoming call processing;
a transmission unit configured to transmit information about the incoming call condition accepted as an input by the input acceptance unit when a call is originated to another information processing apparatus;
a receiving unit configured to receive an audio signal, a data signal, or a mail indicating that communicating with a user of another information processing apparatus via a voice is not established, after a line is connected to another information processing apparatus; and
an output unit configured to output information included in the audio signal, the data signal, or the mail received by the receiving unit.

4. An information processing apparatus comprising:
a receiving unit configured to receive from another information processing apparatus information about an incoming call condition for performing incoming call processing when a call is received from another information processing apparatus connected to the information processing apparatus;
a determination unit configured to determine whether or not the incoming call condition received by the receiving unit is fulfilled;
a generation unit configured to generate a line disconnection request for requesting disconnection of the line remaining connected to the information processing apparatus if the determination unit determines that the incoming call condition is not fulfilled; and
a transmission unit configured to transmit the line disconnection request generated by the generation unit to another information processing apparatus.

5. The information processing apparatus according to claim 4, wherein the incoming call condition comprises a condition where another processing apparatus is in a predetermined area.

6. The information processing apparatus according to claim 4, wherein the incoming call condition comprises a condition where another processing apparatus is not in a predetermined area.

7. The information processing apparatus according to claim 4, wherein the incoming call condition comprises a condition where a battery life is sufficient.

8. The information processing apparatus according to claim 4, wherein the incoming call condition comprises a condition where another processing apparatus is not set to a manner mode.

9. An information processing apparatus comprising:
a receiving unit configured to receive from another information processing apparatus information about incoming call conditions for performing incoming call processing when a call is received from another information processing apparatus connected to the information processing apparatus;
a determination unit configured to determine whether or not the incoming call conditions received by the receiving unit are fulfilled; and
a transmission unit configured to transmit an audio signal, a data signal, or a mail indicating that a connection cannot be established with the information processing apparatus if the determination unit determines that the incoming conditions are not fulfilled.

10. The information processing apparatus according to claim 9, wherein the incoming call condition comprises a condition where another processing apparatus is in a predetermined area.

11. The information processing apparatus according to claim 9, wherein the incoming call condition comprises a condition where another processing apparatus is not in a predetermined area.

12. The information processing apparatus according to claim 9, wherein the incoming call condition comprises a condition where a battery life is sufficient.

13. The information processing apparatus according to claim 9, wherein the incoming call condition comprises a condition where another processing apparatus is not set to a manner mode.
